(19) United States
(12) Patent Application Publication
(10) Pub. No.: US 2018/0121958 A1
(43) Pub. Date: May 3, 2018

(54) NAVIGATION SYSTEM WITH DYNAMIC GEOFENCE MARKETPLACE MECHANISM AND METHOD OF OPERATION THEREOF

(71) Applicant: Telenav, Inc., Santa Clara, CA (US)

(72) Inventors: Gregory Stewart Aist, Santa Clara, CA (US); Aliasgar Mumtaz Husain, Milpitas, CA (US); Casey Carter, Sunnyvale, CA (US); Shalu Grover, Sunnyvale, CA (US)

(21) Appl. No.: 15/337,770

(22) Filed: Oct. 28, 2016

(51) Int. Cl. G06Q 30/02; H04W 4/02

(52) U.S. Cl. CPC G06Q 30/0261; G06Q 30/0267; G06Q 30/0244; H04W 4/021

(57) ABSTRACT

A navigation system comprising of a control circuit configured to determine a targeted exchange for identifying a product or a service associated with the initiating request, determine a geofence goal associated with the targeted exchange for representing a condition regarding the product or the service, and generate a dynamic tailored-geofence including a shape for satisfying the geofence goal associated with the targeted exchange; and a storage circuit, coupled to the control circuit, configured to store the dynamic tailored-geofence.

### TECHNICAL FIELD

An embodiment of the present invention relates generally to a navigation system, and more particularly to a system with dynamic geofence marketplace mechanism.

### BACKGROUND ART

Modern consumer and industrial electronics, especially devices such as graphical navigation systems, televisions, projectors, cellular phones, portable digital assistants, and combination devices, are providing increasing levels of functionality to support modern life including location-based information services. Research and development in the existing technologies can take a myriad of different directions.

As users become more empowered with the growth of mobile communication technology, new and old paradigms begin to take advantage of this new space. One such space is regarding the use of location. The possible applications for providing necessary and relevant information to the user based on the location have not yet been fully utilized.

Thus, a need still remains for a navigation system with a geofence marketplace mechanism. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

An embodiment of the present invention provides a navigation system, including: a control circuit configured to determine a targeted exchange for identifying a product or a service associated with the initiating request, determine a geofence goal associated with the targeted exchange for representing a condition regarding the product or the service, and generate a dynamic tailored-geofence including a shape for satisfying the geofence goal associated with the targeted exchange; and a storage circuit, coupled to the control circuit, configured to store the dynamic tailored-geofence.

An embodiment of the present invention provides a method of operation of a navigation system including: determining a targeted exchange for identifying a product or a service associated with the initiating request; determining a geofence goal associated with the targeted exchange for representing a condition regarding the product or the service; and generating, with a control circuit, a dynamic tailored-geofence including a shape for satisfying the geofence goal associated with the targeted exchange.

An embodiment of the present invention provides a non-transitory computer readable medium including instructions for a navigation system, including: determining a targeted exchange for identifying a product or a service associated with the initiating request; determining a geofence goal associated with the targeted exchange for representing a condition regarding the product or the service; and generating a dynamic tailored-geofence including a shape for satisfying the geofence goal associated with the targeted exchange.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a navigation system with a dynamic geofence marketplace mechanism in an embodiment of the present invention.

FIG. 2 is an example illustration of a database for the navigation system.

FIG. 3 is an example illustration of components of the dynamic geofence.

FIG. 4 is an example of a display interface of the navigation system of FIG. 1.

FIG. 5 is an illustration of an additional aspect of the present invention of FIG. 3.

FIG. 6 is an exemplary block diagram of the navigation system.

FIG. 7 is a control flow of the navigation system.

FIG. 8 is a flow chart of a method of operation of a navigation system in an embodiment of the present invention.

### BEST MODE FOR CARRYING OUT THE INVENTION

The following embodiments of the present invention provide a set of navigation-related functionalities associated with dynamically generating a geofence of varying shape focused on establishing a particular goal regarding a product or service. The shape and size of the geofence can include considerations for response probability, time, distance, travel costs, or a combination thereof associated with traversing to a location.

The geofence can include separate area sets and non-circular outlines. Additional features or functions of the invention can include establishment of a marketplace by providing offers for discounts, incentives, products, services, or a combination thereof for a target group, a marketplace for the sale of products or services between users, or a marketplace for the potential availability of products or services.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

One skilled in the art would appreciate that the format with which navigation information is expressed is not critical to some embodiments of the invention. For example, in some embodiments, navigation information is presented in the format of (X, Y); where X and Y are two coordinates that define the geographic location, i.e., a position of a user.

In an alternative embodiment, navigation information is presented by longitude and latitude related information. In a further embodiment of the present invention, the navigation information also includes a velocity element including a speed component and a heading component.

The term “relevant information” referred to herein can include the navigation information described as well as information relating to points of interest to the user, such as local business, hours of businesses, types of businesses, advertised specials, traffic information, maps, local events, and location based community or personal information.

The term “module” referred to herein can include or be implemented as software, hardware, or a combination thereof in the present invention in accordance with the context in which the term is used. For example, the software can be machine code, firmware, embedded code, and application software. The software can also include a function, a call to a function, a code block, or a combination thereof Also for example, the hardware can be gates, circuitry, processor, computer, integrated circuit, integrated circuit cores, a pressure sensor, an inertial sensor, a microelectromechanical system (MEMS), passive devices, physical non-transitory memory medium having instructions for performing the software function, a portion therein, or a combination thereof

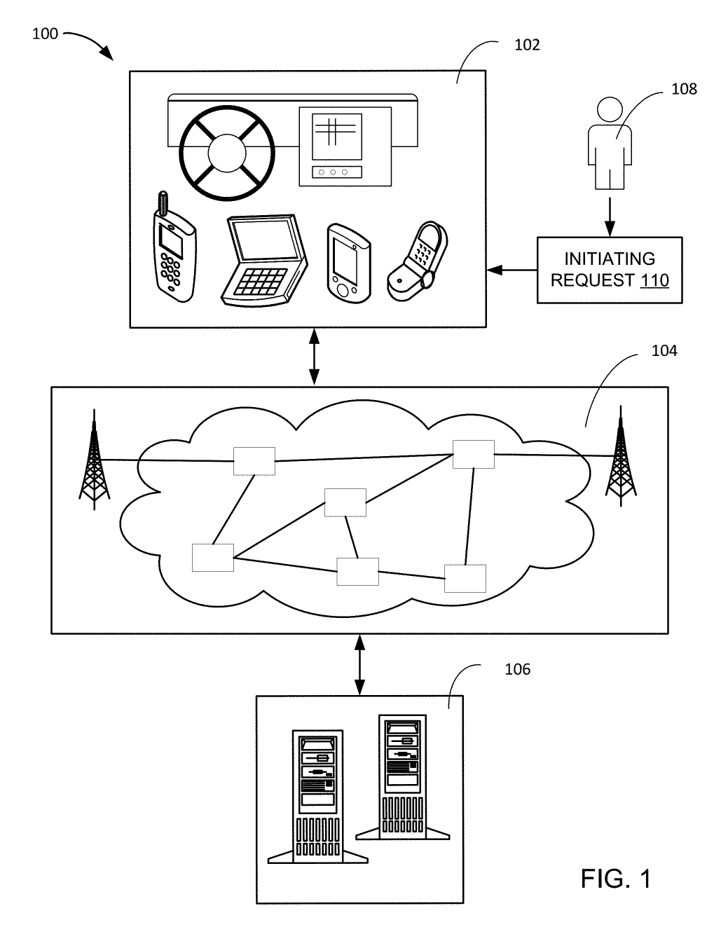

Referring now to FIG. 1, therein is shown a navigation system 100 with an output control mechanism in an embodiment of the present invention. The navigation system 100 includes a first device 102, such as a client or a server, connected to a second device 106, such as a client or server. The first device 102 can communicate with the second device 106 with a network 104, such as a wireless or wired network.

For example, the first device 102 can be of any of a variety of display devices, such as a cellular phone, a personal digital assistant, a notebook computer, an automotive telematics navigation system, a wearable device, a device associated with internet of things (IoT), or other multi-functional mobile communication or entertainment device. The first device 102 can couple, either directly or indirectly, to the network 104 to communicate with the second device 106 or can be a stand-alone device. The first device 102 further can be separate from or incorporated with a vehicle, such as a car, truck, bus, or train.

For illustrative purposes, the navigation system 100 is described with the first device 102 as a mobile computing device, although it is understood that the first device 102 can be different types of devices. For example, the first device 102 can also be a non-mobile computing device, such as a server, a server farm, or a desktop computer.

The second device 106 can be any of a variety of centralized or decentralized computing devices, or video transmission devices. For example, the second device 106 can be a computer, grid computing resources, a virtualized computer resource, cloud computing resource, routers, switches, peer-to-peer distributed computing devices, or a combination thereof

The second device 106 can be centralized in a single room, distributed across different rooms, distributed across different geographical locations, embedded within a telecommunications network. The second device 106 can coupled with the network 104 to communicate with the first device 102. The second device 106 can also be a client type device as described for the first device 102.

For illustrative purposes, the navigation system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with the vehicle, such as the car, the truck, the bus, or the train.

Also for illustrative purposes, the navigation system 100 is described with the second device 106 as a computing device, although it is understood that the second device 106 can be different types of devices. Also for illustrative purposes, the navigation system 100 is shown with the second device 106 and the first device 102 as end points of the network 104, although it is understood that the navigation system 100 can have a different partition between the first device 102, the second device 106, and the network 104. For example, the first device 102, the second device 106, or a combination thereof can also function as part of the network 104.

The network 104 can span and represent a variety of networks. For example, the network 104 can include wireless communication, wired communication, optical, ultrasonic, or a combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the network 104. Further, the network 104 can traverse a number of network topologies and distances. For example, the network 104 can include direct connection, personal area network (PAN), local area network (LAN), metropolitan area network (MAN), wide area network (WAN), or a combination thereof.

The navigation system 100 can be utilized by a requesting member 108. The navigation system 100 can generate a geofence based on interaction with the requesting member 108.

The requesting member 108 can be a party requesting the geofence or receiving benefits thereof. For example, the requesting member 108 can include an end-user, a business entity, the party that views or approves the geofence, an account associated thereto, or a combination thereof. As a more specific example, the requesting member 108 can include an owner or operator of product seller or a service provider intending or desiring to utilize advertisements or discount offers to increase sales. The requesting member 108 can introduce an initiating request 110 for generating the geofence.

The initiating request 110 can represent an input from the requesting member 108 initiating the entire process. The initiating request 110 can include a search string or keywords defining a goal or an objective associated with the geofence. The initiating request 110 can include a command, a condition, a description, a requirement, a goal or an objective, a target product or service, a target time or location, a distance, or a combination thereof associated with the desired outcome or condition, the advertisement or discount offers, the geofence, or a combination thereof

Continuing with the example, the initiating request 110 can include a request or a command from the owner or operator for initiating processing for the geofence associated with the advertisements or discount offers. In a further example, the initiating request 110 can include the command or initiating information from the requesting member 108 to sell tickets previously purchased for a show due to a previously unexpected calendar conflict.

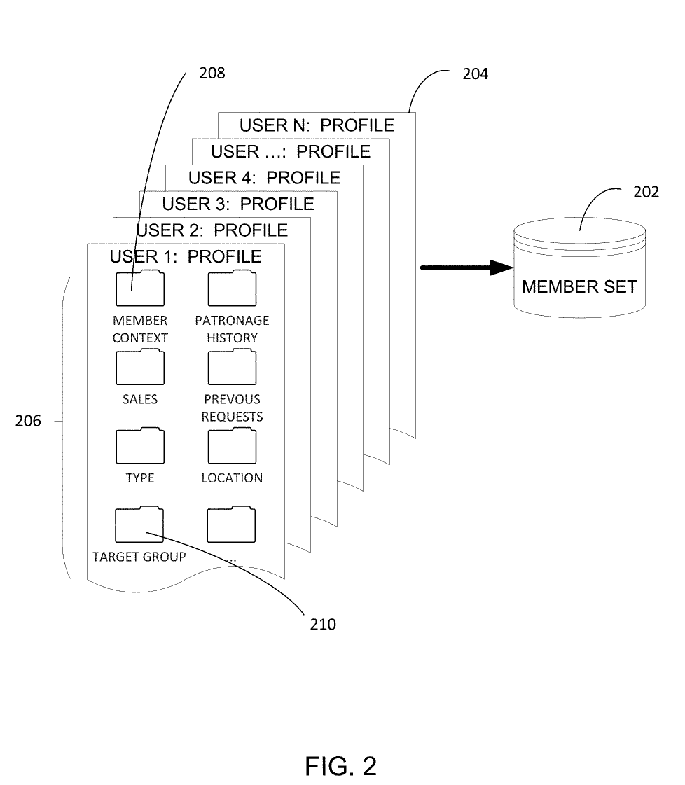

Referring now to FIG. 2, therein is shown an example illustration of a database for the navigation system 100. The illustration can show a representation of a member set database or a portion therein for the present invention. The navigation system 100 can include a member set 202 with a member profile 204 corresponding to one or more members or users in the member set database.

The member set 202 can represent a collection or a grouping of information corresponding to multiple members or users of the navigation system 100. For example, the member set 202 can include a list or a table for accounts, log-in information, identification, detailed descriptions associated thereto, or a combination thereof corresponding to all users or accounts of the navigation system 100, a sub-grouping of users or accounts therein, such as according to location or specific detailed information, or a combination thereof.

The member set 202 can further include the member profile 204 for all users. The member set 202 can be sorted or divided based on region. For example, the member set 202 can be sorted based on a city, such as Sunnyvale, or a region, such as the San Francisco Bay Area. The member set 202 can include information for multiple types of users. For example, the member set 202 can include information for the users targeted in the geofence, for users of the geofence, such as a business or entity, or a combination thereof.

The member profile 204 can represent a description for each user or account. The member profile 204 can include tables, queries, reports, objects, or a combination thereof for the user or account. The member profile 204 can include a member characteristic set 206 with a member context 208 and a target group 210 for each member.

The member characteristic set 206 can represent a description of traits or characteristics for each user or account. The member characteristic set 206 can include descriptions according to categories regarding the user. For example, the member characteristic set 206 can include location history, previous reviews, preferences, patterns, habits, or a combination thereof for the user.

The member characteristic set 206 can also include information about the corresponding user as a product or service provider or a business entity. The member characteristic set 206 can also include information received and updated through the network 104, the second device 106, or a combination thereof.

For example, the member characteristic set 206 can include products offered, type of business, operational hours, reviews, profile of a desired target audience, or a combination thereof In a further example, the member characteristic set 206 can include the number of available parking spaces at a parking lot. The number of available parking spaces can be estimated and updated based on information received or updated to the first device 102, the network 104, the second device 106, or a combination thereof. The parking lot can send or provide the number of available parking spaces based on current status of the parking lot, such as sensor data from each parking space or paid and unpaid time tickets for the parking lot.

The member context 208 can represent a condition, a goal, an objective, or a combination thereof current to the user. The member context 208 can include a categorization, a description thereof, or a combination thereof representing the current situation or information for the user. The member context 208 can include information or estimations regarding activities, duration, or a combination thereof occurring at a current location. For example, the member context 208 can include the number, the show time, the movie title, or a combination thereof, associated with the movie tickets held by the user. The member context 208 can further include information or estimation regarding connection or relationship between corresponding user and other users at located at the same location.

The member context 208 can further represent physical movement of the corresponding user, such as movement direction, current route, or a combination thereof. For example, the member context 208 can include the travel direction for the user towards the desired location, or the location of the user at a restaurant. The member context 208 can further include current travel modality, such as travel by pedestrian, bicycle, vehicle, train, ship, airplane, or a combination thereof.

The target group 210 can represent members in or estimated to be within the geofence, other than the requesting member 108 of FIG. 1, matching a criteria. The target group 210 can be based on the member context 208, previous history or patterns, stored user demographics, or a combination thereof. The target group 210 can further represent members or users estimated to contribute to satisfying the goal or desire of the requesting member 108.

The target group 210 can be specified in the initiating request 110 or determined by information acquired from the member set 202. For example, the target group 210 can be determined as all members in an age range, such as 18-24 year olds or all users traveling in a particular direction within the geofence. Also for example, the target group 210 can include members or users scheduled to be located within the geofence at a future time.

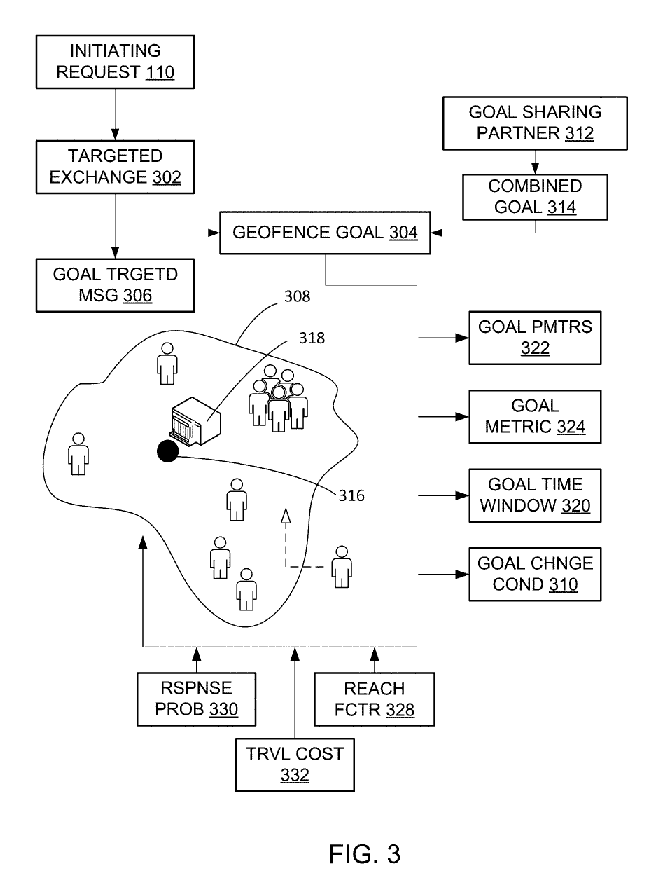

Referring now to FIG. 3, therein is shown an example illustration of components of the dynamic geofence. The navigation system 100 of FIG. 1 can process a targeted exchange 302, a geofence goal 304, a goal-targeted message 306, a dynamic tailored-geofence 308, a goal change condition 310 or a combination thereof. The geofence goal 304 can be processed shared among goal-sharing partners 312 through a combined goal 314.

The targeted exchange 302 can be an identifier for a product or a service associated with the targeted geofence, the initiating request 110, or a combination thereof. For example, the targeted exchange 302 can include offered or open parking spaces, show tickets for sale, clothing for sale, or a taxi service. The targeted exchange 302 can be identified through an input from the requesting member 108 of FIG. 1 as part of the initiating request 110 or as an entry within the member characteristic set 206 for the business entity. The targeted exchange 302 can be associated with a corresponding location 316. The targeted exchange 302 can include a product or a service targeted for sale or purchase using the targeted geofence.

The corresponding location 316 can represent a geographic location related to the targeted exchange 302. The corresponding location 316 can include an address for the business entity or a point of interest 318. The point of interest 318 can represent a business entity, a landmark, or service provider associated with the targeted exchange 302. For example, the point of interest 318 for the targeted exchange 302, such as shoes can be a shoe store or a shopping mall. In a further example, the point of interest 318, such as an amusement park, can be associated with discounts for food purchased at the amusement park.

The corresponding location 316 can also include the current location of the requesting member 108 or the user associated with the targeted exchange 302. For example, the corresponding location 316 can be a parking lot where spaces are available. Also for example, the corresponding location 316 can be associated with the current or future geographic location of the requesting member 108 or frequented or known geographic location associated with the requesting member 108, such as a place of business or home.

The geofence goal 304 can represent a desired condition or result for or associated with the targeted exchange 302. The geofence goal 304 can include the desired or result desired by the requesting member 108 regarding the targeted exchange 302. The geofence goal 304 can be described by the initiating request 110, extracted from the member characteristic set 206, or a combination thereof. For example, the geofence goal 304 can include a percentage increase in sales of clothing at a downtown store, filling the parking lot on weekends, or an increase in happy hour patronage at a restaurant.

The geofence goal 304 can include a goal time window 320 for meeting the geofence goal 304. The geofence goal 304 can include goal parameters 322 and a goal metric 324 for measuring the geofence goal 304.

The goal time window 320 can represent a duration of time for implementing the geofence and meeting or satisfying the geofence goal 304. The goal time window 320 can include the duration, a start time, and an end time for implementing the geofence. For example, for the geofence goal 304 of increasing happy hour patronage the goal time window 320 can have the duration of 3 hours, starting at 3 pm and ending at 6 pm. In a further example, a two week ad campaign to increase clothing sales can have the duration of two weeks starting on Sunday.

The goal parameters 322 can represent factors related to establishing the goal. The goal parameters 322 can include the factors that change over time. For example, the goal parameters 322 can include time, distance, availability or remaining amount of the targeted exchange 302, or a combination thereof. The goal parameters 322 can also include the factors that remain constant. For example, for a restaurant wanting to increase sales, the goal parameters 322 can include the operational hours of the restaurant or the total number of tables in the restaurant. In a further example, the goal parameters 322 can include the number of parking spaces in the parking lot or the number of filled spots.

The navigation system 100 can determine the goal parameters 322 required for quantifying the geofence goal 304. The goal parameters 322 can be determined based on information received from the initiating request 110. The goal parameters 322 can also be predetermined through entries within the member set 202. For example, the member set 202 can include the goal parameters 322 that are predefined by the requesting member 108 for the geofence goal 304. In a further example, the navigation system 100 can estimate the goal parameters 322 based on the type of business, such as the goal parameters 322 of theater capacity, sold tickets, show times, or a combination thereof, for a movie theater.

The navigation system 100 can determine the goal parameters 322 based on the event initiating the dynamic tailored-geofence 308. For example, the navigation system 100 can identify a missed arrival time for the last show at the movie theater as the initiating event. The missed arrival can trigger the dynamic tailored-geofence 308 to create an offer to resell the movie tickets to the target group 210 within the dynamic tailored-geofence 308 encompassing the movie theater. The navigation system 100 can determine the goal parameters 322 of the show time, the number of tickets for sale, and the movie title.

The goal metric 324 can represent a measurement of the geofence goal 304. The goal metric 324 can be based on the goal parameters 322. The goal metric 324 can include a quantification or a quantitative representation of the geofence goal 304. The goal metric 324 can be a value, a percentage, or a combination thereof for the geofence goal 304 based on the goal parameters 322.

For example, for the geofence goal 304 to fill all the seats for the last show time of a movie, the goal metric 324 can include the percentage of filled seats or sold tickets. The goal parameters 322 can include the total number of seats and the number of available seats. The goal metric 324 can be calculated as 89% when the theater holds 100 seats and there are 11 seats available.

In a further example, for the geofence goal 304 of increasing sales at a clothing store, the goal metric 324 can include total daily sales. The goal metric 324 can be calculated as the percentage increase based on difference between the total daily sales on day 1 and the total daily sales on day N, divided by the total daily sales at day 1.

The goal-targeted message 306 can represent a communication sent to the user. The goal-targeted message 306 can be associated with the targeted exchange 302, the geofence, or a combination thereof. The goal-targeted message 306 can include benefits, offers, discounts, suggestions, or reminders for meeting the geofence goal 304. For example, the goal-targeted message 306 can include a discount coupon for pizza. In a further example, the goal-targeted message 306 can include a text message suggesting a taxi ride to a final destination.

The navigation system 100 can generate the goal-targeted message 306 based on the initiating request 110. The navigation system 100 can send or transmit the goal-targeted message 306 to the member set 202, the target group 210, a segment or a grouping therein, or a combination thereof. The navigation system 100 can send or transmit the goal-targeted message 306 for satisfying the geofence goal 304 or for facilitating a condition or a result associated thereto.

The goal-targeted message 306 can include an offer with a dynamic benefit level 326. The dynamic benefit level 326 can represent a benefit to the user including a provider or a consumer of the targeted exchange 302. The dynamic benefit level 326 can include an offer which is specifically customized based on information in the member characteristic set 206, the time of day, or the corresponding location 316 of the user within the geofence.

For example, the goal-targeted message 306 can include the dynamic benefit level 326 such as various discount percentages based on a number of previous visits or transactions associated with the targeted exchange 302 for the corresponding recipient consumer. In a further example, the goal-targeted message 306 can include the dynamic benefit level 326 such as offers for a type of shoe for the user based on the occupation identified in the member characteristic set 206. Also for example, the dynamic benefit level 326 can include a discount level or a benefit specific to the responding recipient based on a travel distance for the targeted exchange 302, a work or home address or location of the recipient, or a combination thereof.

The dynamic tailored-geofence 308 can represent a machine readable description for a monitored boundary. The dynamic tailored-geofence 308 can include a description of the geofence with a shape unique to meeting a goal, requested by the requesting member 108, or based on the current context. For example, the dynamic tailored-geofence 308 can include a non-circular boundary or boundary sets separated by geographic features, such as a river or a freeway. In addition, the dynamic tailored-geofence 308 can include a description of the geofence based on a reachability factor 328, a response probability 330, or travel costs 332.

The reachability factor 328 can represent an effort related to traversal to the corresponding location 316. The reachability factor 328 can include the effort based on distance, time, monetary value, or a combination thereof associated with traversal to the desired location. The reachability factor 328 can be based on calculated routes, map features, or a combination thereof. For example, the reachability factor 328 can be based on effort required to cross a bridge between the potential responder for the targeted exchange 302 and the corresponding location 316 for the targeted exchange 302.

In a further example, the reachability factor 328 can be based on the calculated routes between highway routes and surface street routes to arrive at the corresponding location 316. The navigation system 100 can calculate the available routes allowing users to travel to the corresponding location 316 within the goal time window 320. For areas which would not allow arrival to the corresponding location 316 within the goal time window 320, the reachability factor 328 can be very low compared to areas where the calculated routes allowed arrival within the goal time window 320.

The response probability 330 can represent the probability or the likelihood of the user to travel to the corresponding location 316 based on the goal-targeted message 306. The response probability 330 can be calculated using information in the member profile 204. The response probability 330 can be estimated by the system, can be fixed, or can be calculated based on the types of goals, products, previous offerings, or a combination thereof. The response probability 330 can be estimated or calculated for each member in an initial target group based on their history, preference, estimated current need, or a combination thereof.

For example, the response probability 330 can be based on a current travel direction of the user where the user traveling away from the corresponding location 316 would be associated with a lower estimated probability in comparison to the user traveling toward the corresponding location 316. In a further example, the response probability 330 can be calculated based on the number of previous visits to the corresponding location 316.

The travel costs 332 can represent monetary costs associated with traversing to the corresponding location 316. The travel costs 332 can include bus fare, mileage, tolls, parking, or a combination thereof. The travel costs 332 can include the monetary costs associated with the mode of travel used. For example, the travel costs 332 can be based on the cost of bus fare or the ride service charge associated with traversing to the corresponding location 316.

The dynamic tailored-geofence 308 can be adjusted based on a goal change condition 310. For example the dynamic tailored-geofence 308 can be adjusted in real time based on the progress of meeting the geofence goal 304. In a further example, the size of the dynamic tailored-geofence 308 can decrease as the number of available parking spaces decreases or can increase as closing time approaches at a restaurant.

The goal change condition 310 can represent a condition for meeting the geofence goal 304. The goal change condition 310 can initiate real time changes to the geofence boundary or the goal-targeted message 306. The goal change condition 310 can be based on time, the goal metric 324, the goal parameters 322, or a combination thereof. For example, the goal change condition 310 can be based on an approaching end time for the goal time window 320. The navigation system 100 can decrease the geofence boundary when within an hour of the goal time window 320 end time. In a further example, for the geofence goal 304 of filling a parking lot, the navigation system 100 can decrease the geofence boundary when the parking lot capacity drops below 20%.

The goal-sharing partners 312 can represent two or more entities that share the goal-targeted message 306. The goal-sharing partners 312 can be identified in the member set 202 or identified by the initiating request 110. For example, the goal-sharing partners 312 can include neighboring pizza and ice cream shops wanting to increase sales during the weekday lunch hour. In a further example, the goal-sharing partners 312 can include a movie theater and a ride service wanting to increase revenue by selling more tickets for a final show time by offering discounted rides home after the end of the show.

The combined goal 314 can represent the goal shared between goal-sharing partners 312. The combined goal 314 can be received during the initiating request 110, described in the member set 202, or a combination thereof. The combined goal 314 can include a shared objective for the goal-sharing partners 312. The combined goal 314 can also include separate objectives for each partner.

For example, the combined goal 314 can include increasing sales by 10% by the second fiscal quarter for two downtown clothing stores. In a further example, for the goal-sharing partners 312, such as the movie theater and the ride service, the combined goal 314 can include filling theater seats for the final movie show time for the movie theater and increase name brand recognition for the ride service.

The dynamic tailored-geofence 308 can further account for or process the potential responders' future location, such as illustrated with a dashed line in FIG. 3. For example, the navigation system 100 can determine the multiple users' future location based on patterns in locations in the corresponding history, based on schedule calendar, or a combination thereof

The navigation system 100 can account for the potential responders' future location in processing the dynamic tailored-geofence 308. The navigation system 100 can further send information, such as offers, advertisements, or a combination thereof based on the potential responders with the future location within the dynamic tailored-geofence 308 during the goal time window 320.

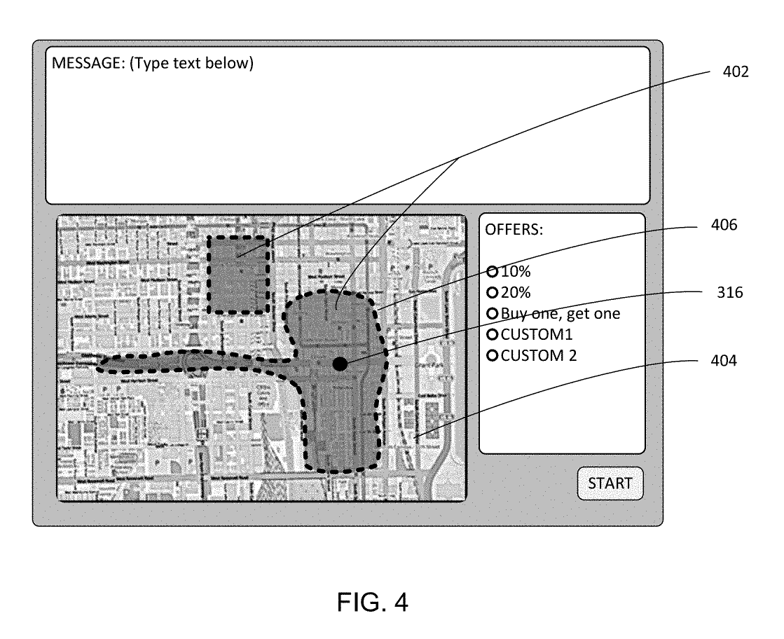

Referring now to FIG. 4, therein is shown an example of a display interface of the navigation system 100 of FIG. 1. The display interface can show the dynamic tailored-geofence 308 of FIG. 3 with a separated-area set 402. The navigation system 100 can display a map 404 including the corresponding location 316. The dynamic tailored-geofence 308 can be displayed on the navigation system 100 and can include various shapes and sizes. For example, the dynamic tailored-geofence 308 can include a non-circular outline 406, the separated-area set 402, or a combination thereof.

The map 404 can include or represent the geographic location of the corresponding location 316. The navigation system 100 can display or overlay the dynamic tailored-geofence 308 on the map 404.

The non-circular outline 406 can represent a boundary or a set of edges for the dynamic tailored-geofence 308 defined using parameters other than or in addition to one or more focal points and one or more fixed distances associated with the focal points. The non-circular outline 406 can include the boundary that is not circular or elliptical.

The dynamic tailored-geofence 308 can similarly be based on a shape specific to the current context or situation of the requesting member 108, the targeted exchange 302 of FIG. 3, or a combination thereof. The dynamic tailored-geofence 308 can also be defined using parameters other than or in addition to an existing divisions or shapes, such as a municipal boundaries or zones predetermined by other entities. The shape of the dynamic tailored-geofence 308, including the non-circular outline 406, can be a polygon based on the reachability factor 328 of FIG. 3, the response probability 330 of FIG. 3, the travel costs 332 of FIG. 3, or a combination thereof.

The separated-area set 402 can represent the geofence description made up of multiple separate areas not connected by a single continuous outline or boundary. For example, the separated-area set 402 can include two or more areas within a city separated by a river, a highway, a specific area, or a combination thereof. The navigation system 100 can use the separated-area set 402 to consider multiple separate zones as one data set for processing purposes.

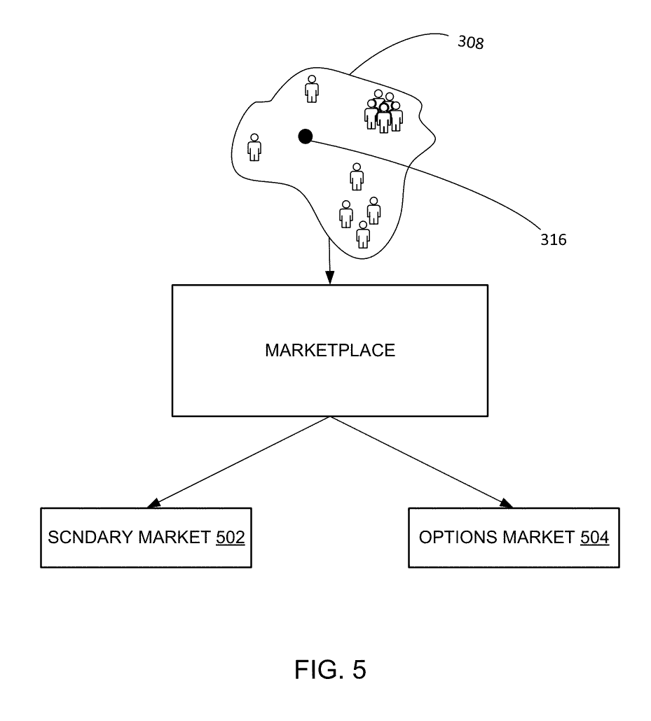

Referring now to FIG. 5, therein is shown an illustration of an additional aspect of the navigation system 100 of FIG. 1. The navigation system 100 can include a feature for creating a secondary marketplace 502 for selling goods and services between the users. The navigation system 100 can further include a feature for creating an options marketplace 504 for selling potential goods and services between the users.

The secondary marketplace 502 can represent a method, a process, a system, a mechanism, an interface, or a combination thereof for allowing previous buyers or consumers to become a seller. The secondary marketplace 502 can exclude stores, organization, or other traditional providers of the goods or services. The secondary marketplace 502 can be based on a platform implemented by the navigation system 100 for dynamically enabling consumer users to sell or resell goods or services based on geographic locations or areas. The secondary marketplace 502 can be implemented based on or using the dynamic tailored-geofence 308.

For example, the secondary marketplace 502 can allow the consumer or patron to resell, transfer, or offer goods and services to another member within the dynamic tailored-geofence 308, such as an offer to share a taxi ride to downtown. The resell, transfer, or the offer can be based on the reachability factor 328 of FIG. 3 of the member to traverse to the corresponding location 316 corresponding to the taxi pickup location by a specified amount of time corresponding to the goal time window 320 of FIG. 3.

In a further example, the secondary marketplace 502 can establish the electronic market for reselling tickets for a concert. The navigation system 100 can consider the response probability 330 of FIG. 3 of the potential responders to purchase the tickets based on the preferences and ability to collect the tickets as implemented in the dynamic tailored-geofence 308.

The navigation system 100 can search for and identify potential buyers within the dynamic tailored-geofence 308 of the secondary marketplace 502 based on a current or future location, the member context 208 of FIG. 2, preferences, purchase history, or a combination thereof. For example, the navigation system 100 can identify potential buyers for unused movie tickets based on previous purchase history, such as movies watched, or frequency at the corresponding location 316, such as the movie theater.

The navigation system 100 can generate the initiating request 110 of FIG. 1 for potential responders currently or scheduled to be within the dynamic tailored-geofence 308 for the secondary marketplace 502. For example, the navigation system 100 can automatically generate the initiating request 110 based on the user corresponding to the requesting member 110 of FIG. 1 missing an event, determined based on current location of the requesting member 110 for example, or the previously unexpected calendar conflict, determined based on creation of a conflicting calendar event for example.

The options marketplace 504 can represent the electronic market, including a method, a process, a system, a mechanism, an interface, or a combination thereof, for selling conditional goods or services. The conditional goods or services can represent an option, but not an obligation to purchase the goods or services at a later time. For example, the options marketplace 504 can be used to sell dinner reservations or the option to purchase movie tickets at a set price.

The option to purchase the conditional goods or services can expire based on a time dependent condition or event. For example, the conditional dinner reservation can expire based on the potential responder not arriving 15 minutes prior to the reservation time. In a further example, the conditional movie ticket option can expire based on the tickets not purchased by a specified date.

The options marketplace 504 can further represent the electronic marketplace for selling the goods or services that would have otherwise remained unused. For example, in the event of a projected missed or late arrival for a dinner reservation, the dinner reservation could be resold by the restaurant in the options marketplace 504. In a further example, the users could pay for the option to purchase movie tickets to a sold out show in the event that the original movie ticket holder could not use the tickets. The seller can resell the seat that would have otherwise remained empty.

The options marketplace 504 can utilize a bidding system for selling conditional goods and services. For example, the options marketplace 504 can be used to make a conditional reservation at the restaurant. The initial user can bid to make the conditional reservation at the restaurant that can be held until 15 minutes before the scheduled time, and then released to the options marketplace 504. The reservation can be offered or provided to other potential customers within the dynamic tailored-geofence 308.

For the options marketplace 504, the responding user purchases the guaranteed commitment for some form of consideration. The user purchases the right to exercise that commitment at a later time. For the above example, the option is exercised by showing up at the table within the time specified. The option expires based on not showing up or by not being close enough to make it on time, depending on the type of option purchased.

In a further example, the options marketplace 504 can be used for entertainment bidding systems such as nightclub admissions, special exhibits at museums, and movie premieres. In these cases the option might be exercised not by showing up on time, but rather in the conventional way of purchasing the underlying commodity such as the ticket or admission. The seller can resell the seat that would otherwise have gone empty. For example, a passenger might pay $1 to reserve a spot which would expire if not converted to a prepaid ticket ten minutes before the scheduled time.

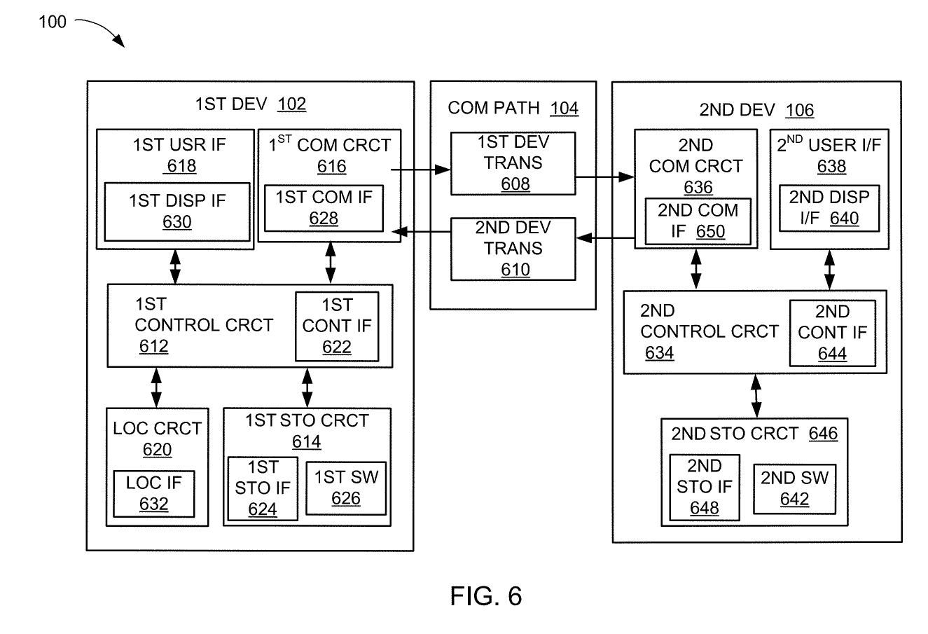

Referring now to FIG. 6, therein is shown an exemplary block diagram of the navigation system 100. The navigation system 100 can include the first device 102, the network 104, and the second device 106. The first device 102 can send information in a first device transmission 608 over the network 104 to the second device 106. The second device 106 can send information in a second device transmission 610 over the network 104 to the first device 102.

For illustrative purposes, the navigation system 100 is shown with the first device 102 as a client device, although it is understood that the navigation system 100 can have the first device 102 as a different type of device. For example, the first device 102 can be a server having a display interface.

Also for illustrative purposes, the navigation system 100 is shown with the second device 106 as a server, although it is understood that the navigation system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control circuit 612, a first storage circuit 614, a first communication circuit 616, and a first user interface 618, and a location circuit 620. The first control circuit 612 can include a first control interface 622. The first control circuit 612 can execute a first software 626 to provide the intelligence of the navigation system 100.

The first control circuit 612 can be implemented in a number of different manners. For example, the first control circuit 612 can be a processor, an application specific integrated circuit (ASIC) an embedded processor, a microprocessor, a hardware control logic, a hardware finite state machine (FSM), a digital signal processor (DSP), or a combination thereof. The first control interface 622 can be used for communication between the first control circuit 612 and other functional circuits in the first device 102. The first control interface 622 can also be used for communication that is external to the first device 102.

The first control interface 622 can receive information from the other functional circuits or from external sources, or can transmit information to the other functional circuits or to external destinations. The external sources and the external destinations refer to sources and destinations external to the first device 102.

The first control interface 622 can be implemented in different ways and can include different implementations depending on which functional circuits or external circuits are being interfaced with the first control interface 622. For example, the first control interface 622 can be implemented with a pressure sensor, an inertial sensor, a microelectromechanical system (MEMS), optical circuitry, waveguides, wireless circuitry, wireline circuitry, or a combination thereof

The first storage circuit 614 can store the first software 626. The first storage circuit 614 can also store the relevant information, such as data representing incoming images, data representing previously presented image, sound files, or a combination thereof

The first storage circuit 614 can be a volatile memory, a nonvolatile memory, an internal memory, an external memory, or a combination thereof. For example, the first storage circuit 614 can be a nonvolatile storage such as non-volatile random access memory (NVRAM), Flash memory, disk storage, or a volatile storage such as static random access memory (SRAM).

The first storage circuit 614 can include a first storage interface 624. The first storage interface 624 can be used for communication between the first storage circuit 614 and other functional circuits in the first device 102. The first storage interface 624 can also be used for communication that is external to the first device 102.

The first storage interface 624 can receive information from the other functional circuits or from external sources, or can transmit information to the other functional circuits or to external destinations. The external sources and the external destinations refer to sources and destinations external to the first device 102.

The first storage interface 624 can include different implementations depending on which functional circuits or external circuits are being interfaced with the first storage circuit 614. The first storage interface 624 can be implemented with technologies and techniques similar to the implementation of the first control interface 622.

The first communication circuit 616 can enable external communication to and from the first device 102. For example, the first communication circuit 616 can permit the first device 102 to communicate with the second device 106, an attachment, such as a peripheral device or a desktop computer, and the network 104.

The first communication circuit 616 can also function as a communication hub allowing the first device 102 to function as part of the network 104 and not limited to be an end point or terminal circuit to the network 104. The first communication circuit 616 can include active and passive components, such as microelectronics or an antenna, for interaction with the network 104.

The first communication circuit 616 can include a first communication interface 628. The first communication interface 628 can be used for communication between the first communication circuit 616 and other functional circuits in the first device 102. The first communication interface 628 can receive information from the other functional circuits or can transmit information to the other functional circuits.

The first communication interface 628 can include different implementations depending on which functional circuits are being interfaced with the first communication circuit 616. The first communication interface 628 can be implemented with technologies and techniques similar to the implementation of the first control interface 622.

The first user interface 618 allows a user (not shown) to interface and interact with the first device 102. The first user interface 618 can include an input device and an output device. Examples of the input device of the first user interface 618 can include a keypad, a touchpad, soft-keys, a keyboard, a microphone, a camera, an infrared sensor for receiving remote signals, or any combination thereof to provide data and communication inputs.

The first user interface 618 can include a first display interface 630. The first display interface 630 can include an output device. The first display interface 630 can include a display, a projector, a video screen, a speaker, or any combination thereof.

The first control circuit 612 can operate the first user interface 618 to display information generated by the navigation system 100. The first control circuit 612 can also execute the first software 626 for the other functions of the navigation system 100, including receiving location information from the location circuit 620. The first control circuit 612 can further execute the first software 626 for interaction with the network 104 via the first communication circuit 616.

The location circuit 620 can generate location information, current heading, current acceleration, and current speed of the first device 102, as examples. The location circuit 620 can be implemented in many ways. For example, the location circuit 620 can function as at least a part of the global positioning system, an inertial navigation system, a cellular-tower location system, a pressure location system, or any combination thereof. Also, for example, the location circuit 620 can utilize components such as an accelerometer or GPS receiver.

The location circuit 620 can include a location interface 632. The location interface 632 can be used for communication between the location circuit 620 and other functional circuits in the first device 102. The location interface 632 can also be used for communication external to the first device 102.

The location interface 632 can receive information from the other functional circuits or from external sources, or can transmit information to the other functional circuits or to external destinations. The external sources and the external destinations refer to sources and destinations external to the first device 102.

The location interface 632 can include different implementations depending on which functional circuits or external circuits are being interfaced with the location circuit 620. The location interface 632 can be implemented with technologies and techniques similar to the implementation of the first control circuit 612.

The second device 106 can be optimized for implementing an embodiment of the present invention in a multiple device embodiment with the first device 102. The second device 106 can provide the additional or higher performance processing power compared to the first device 102. The second device 106 can include a second control circuit 634, a second communication circuit 636, a second user interface 638, and a second storage circuit 646.

The second user interface 638 allows a user (not shown) to interface and interact with the second device 106. The second user interface 638 can include an input device and an output device. Examples of the input device of the second user interface 638 can include a keypad, a touchpad, soft-keys, a keyboard, a microphone, a camera, or any combination thereof to provide data and communication inputs. Examples of the output device of the second user interface 638 can include a second display interface 640. The second display interface 640 can include a display, a projector, a video screen, a speaker, or any combination thereof.

The second control circuit 634 can execute a second software 642 to provide the intelligence of the second device 106 of the navigation system 100. The second software 642 can operate in conjunction with the first software 626. The second control circuit 634 can provide additional performance compared to the first control circuit 612.

The second control circuit 634 can operate the second user interface 638 to display information. The second control circuit 634 can also execute the second software 642 for the other functions of the navigation system 100, including operating the second communication circuit 636 to communicate with the first device 102 over the network 104.

The second control circuit 634 can be implemented in a number of different manners. For example, the second control circuit 634 can be a processor, an embedded processor, a microprocessor, hardware control logic, a hardware finite state machine (FSM), a digital signal processor (DSP), or a combination thereof

The second control circuit 634 can include a second control interface 644. The second control interface 644 can be used for communication between the second control circuit 634 and other functional circuits in the second device 106. The second control interface 644 can also be used for communication that is external to the second device 106.

The second control interface 644 can receive information from the other functional circuits or from external sources, or can transmit information to the other functional circuits or to external destinations. The external sources and the external destinations refer to sources and destinations external to the second device 106.

The second control interface 644 can be implemented in different ways and can include different implementations depending on which functional circuits or external circuits are being interfaced with the second control interface 644. For example, the second control interface 644 can be implemented with a pressure sensor, an inertial sensor, a microelectromechanical system (MEMS), optical circuitry, waveguides, wireless circuitry, wireline circuitry, or a combination thereof.

A second storage circuit 646 can store the second software 642. The second storage circuit 646 can also store the information such as data representing incoming images, data representing previously presented image, sound files, or a combination thereof . The second storage circuit 646 can be sized to provide the additional storage capacity to supplement the first storage circuit 614.

For illustrative purposes, the second storage circuit 646 is shown as a single element, although it is understood that the second storage circuit 646 can be a distribution of storage elements. Also for illustrative purposes, the navigation system 100 is shown with the second storage circuit 646 as a single hierarchy storage system, although it is understood that the navigation system 100 can have the second storage circuit 646 in a different configuration. For example, the second storage circuit 646 can be formed with different storage technologies forming a memory hierarchal system including different levels of caching, main memory, rotating media, or off-line storage.

The second storage circuit 646 can be a volatile memory, a nonvolatile memory, an internal memory, an external memory, or a combination thereof. For example, the second storage circuit 646 can be a nonvolatile storage such as non-volatile random access memory (NVRAM), Flash memory, disk storage, or a volatile storage such as static random access memory (SRAM).

The second storage circuit 646 can include a second storage interface 648. The second storage interface 648 can be used for communication between the second storage circuit 646 and other functional circuits in the second device 106. The second storage interface 648 can also be used for communication that is external to the second device 106.

The second storage interface 648 can receive information from the other functional circuits or from external sources, or can transmit information to the other functional circuits or to external destinations. The external sources and the external destinations refer to sources and destinations external to the second device 106.

The second storage interface 648 can include different implementations depending on which functional circuits or external circuits are being interfaced with the second storage circuit 646. The second storage interface 648 can be implemented with technologies and techniques similar to the implementation of the second control interface 644.

The second communication circuit 636 can enable external communication to and from the second device 106. For example, the second communication circuit 636 can permit the second device 106 to communicate with the first device 102 over the network 104.

The second communication circuit 636 can also function as a communication hub allowing the second device 106 to function as part of the network 104 and not limited to be an end point or terminal circuit to the network 104. The second communication circuit 636 can include active and passive components, such as microelectronics or an antenna, for interaction with the network 104.

The second communication circuit 636 can include a second communication interface 650. The second communication interface 650 can be used for communication between the second communication circuit 636 and other functional circuits in the second device 106. The second communication interface 650 can receive information from the other functional circuits or can transmit information to the other functional circuits.

The second communication interface 650 can include different implementations depending on which functional circuits are being interfaced with the second communication circuit 636. The second communication interface 650 can be implemented with technologies and techniques similar to the implementation of the second control interface 644.

The first communication circuit 616 can coupled with the network 104 to send information to the second device 106 in the first device transmission 608 The second device 106 can receive information in the second communication circuit 636 from the first device transmission 608 of the network 104.

The second communication circuit 636 can coupled with the network 104 to send information to the first device 102 in the second device transmission 610 The first device 102 can receive information in the first communication circuit 616 from the second device transmission 610 of the network 104. The navigation system 100 can be executed by the first control circuit 612 the second control circuit 634, or a combination thereof. For illustrative purposes, the second device 106 is shown with the partition having the second user interface 638, the second storage circuit 646, the second control circuit 634, and the second communication circuit 636, although it is understood that the second device 106 can have a different partition. For example, the second software 642 can be partitioned differently such that some or all of its function can be in the second control circuit 634 and the second communication circuit 636. Also, the second device 106 can include other functional circuits not shown in FIG. 6 for clarity.

The functional circuits in the first device 102 can work individually and independently of the other functional circuits. The first device 102 can work individually and independently from the second device 106 and the network 104.

The functional circuits in the second device 106 can work individually and independently of the other functional circuits. The second device 106 can work individually and independently from the first device 102 and the network 104.

The functional circuits described above can be implemented in hardware. For example, one or more of the functional circuits can be implemented using a gate, circuitry, a processor, a computer, integrated circuit, integrated circuit cores, a pressure sensor, an inertial sensor, a microelectromechanical system (MEMS), a passive device, a physical non-transitory memory medium having instructions for performing the software function, a portion therein, or a combination thereof.

For illustrative purposes, the navigation system 100 is described by operation of the first device 102 and the second device 106. It is understood that the first device 102 and the second device 106 can operate any of the modules and functions of the navigation system 100.

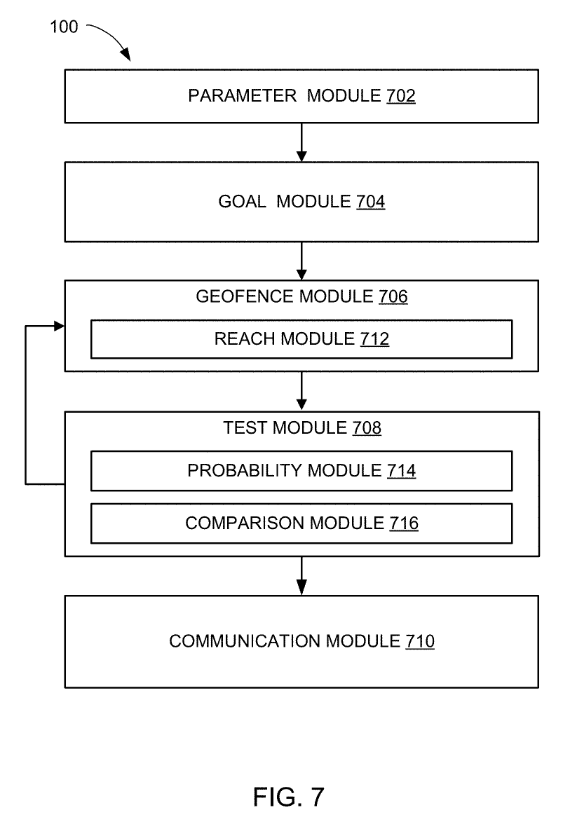

Referring now to FIG. 7, therein is shown a control flow of the navigation system 100. The navigation system 100 can include a parameter module 702, a goal module 704, a geofence module 706, a test module 708, and a communication module 710, or a combination thereof.

The parameter module 702 can be coupled to the goal module 704 using wired or wireless connections, by having an output of one module as an input of the other module, by having operations of one module influence operations of the other module, or a combination thereof. Similarly, the goal module 704 can be coupled to the geofence module 706, the geofence module 706 can be coupled to the test module 708, the communication module 710, or a combination thereof; the test module 708 can be coupled to the communication module 710.

The parameter module 702 is configured to manage information related to user profiles, user history, map data, or a combination thereof. The parameter module 702 can manage the information by receiving, accessing, storing, or updating the information to the first device 102 of FIG. 1, the network 104 of FIG. 1, the second device 106 of FIG. 1, or a combination thereof. The parameter module 702 can further manage the information by identifying, determining, or detecting patterns, habits, locations, or preferences associated with the information.

For example, the parameter module 702 can manage the information by managing the member set 202 of FIG. 2, the member context 208 of FIG. 2, data associated with the map 404 of FIG. 4, or a combination thereof. In a further example, the parameter module 702 can manage the information by receiving the user location information through location based services reports or can receive the initiating request 110 of FIG. 1.

The parameter module 702 can further receive the initiating request 110 based on a field inquiry in the display interface. The parameter module 702 can receive the initiating request 110 based on a field inquiry from the first user interface 618 of FIG. 6, the first communication interface 628 of FIG. 6, the first control interface 622 of FIG. 6, the first storage interface 624 of FIG. 6, the location interface 632 of FIG. 6, the second user interface 638 of FIG. 6, the second display interface 640 of FIG. 6, the second control interface 644 of FIG. 6, the second storage interface 648 of FIG. 6, or a combination thereof.

The parameter module 702 can manage the member set 202 by updating the member characteristic set 206 of FIG. 2. The parameter module 702 can update the member characteristic set 206 using the information received as the input from the user, the first device 102, the network 104, or the second device 106, or a combination thereof. The parameter module 702 can further utilize various engines or models for storing the information in the member set 202. For example, the parameter module 702 can store the information within tables or database software using predefined fields of values, string variable, variable characters, or a combination thereof.

The parameter module 702 can update the member characteristic set 206 based on monitored and accessed the information from the initiating request 110, the user search history, information from previous implementation of the dynamic tailored-geofence 308 of FIG. 3, location tracking of the user, routes identified, or a combination thereof. For example, the parameter module 702 can update the information about movie search history for the user. In a further example, the parameter module 702 can access information that can be used as triggers for adjusting the dynamic tailored-geofence 308 based on accessing information in the member characteristic set 206 such as closing time or happy hour at the restaurant.

The parameter module 702 can manage the member context 208 by accessing and updating information related to the current or upcoming condition of the user. For example, the parameter module 702 can access location based services to identify the current location of the users of the navigation system 100. The parameter module 702 can further update the information about the location of the users to the corresponding instance of the member characteristic set 206. In a further example the parameter module 702 can determine the information by updating the member characteristic set 206 with the information associated with upcoming events scheduled for the each of the users, such as a calendar event or a ticket purchase for a movie.

The parameter module 702 can update information based on the member context 208 to predefined field entries in the member characteristic set 206. The parameter module 702 can also update and store entries of the member context 208 to detect patterns, relationships, habits, preferences, or a combination thereof for each of the users based on previous entries of the member context 208. The patterns, relations, habits, preferences, or a combination thereof can be used to provide offerings, products, services, or a combination thereof.

For example, the entries for the movie tickets purchased by one of the users can be used to establish movie genre preferences for the corresponding user. In a further example, the entries of the location of a specific user that frequented a neighborhood of a city can establish a relationship with the neighborhood. The navigation system 100 can provide communication for products, services, offerings, or a combination thereof related to the neighborhood, such as discounts for local restaurants or products for sale from users in the neighborhood.

The parameter module 702 can receive the information to the member context 208 utilizing the first communication circuit 616 of FIG. 6, the second communication circuit 636 of FIG. 6, the location circuit 632, or a combination thereof. The parameter module 702 can update and access the information to the member set 202, the member characteristic set 206, the member context 208, the map 404, or a combination thereof utilizing the first communication circuit 616, the first control circuit 612 of FIG. 6, the second communication circuit 636, the second control circuit 634 of FIG. 6, the location circuit 632, or a combination thereof.

The parameter module 702 can determine a need to establish the dynamic tailored-geofence 308. The parameter module 702 can identify the need to establish the dynamic tailored-geofence 308 based on the initiating request 110, monitored information, the received information, an event cancelation, the input from the requesting member 108 of FIG. 1, or a combination thereof. For example, the parameter module 702 can determine the need for the dynamic tailored-geofence 308 based on receiving the initiating request 110 from the requesting member 108 In a further example, the parameter module 702 can determine the request for the dynamic tailored-geofence 308 based on a scheduling conflict in the event calendar.

The parameter module 702 can identify the need to establish or update the dynamic tailored-geofence 308 based on a contextual trigger or an external trigger for establishing or updating the dynamic tailored-geofence 308. For example, the parameter module 702 can identify the need to establish the dynamic tailored-geofence 308 based on a holiday or major events. In a further example, the parameter module 702 can utilize service provider suggested triggers, such as an upcoming happy hour to identify the need to establish the dynamic tailored-geofence 308.

The parameter module 702 can identify the need to establish the dynamic tailored-geofence 308 utilizing the first control circuit 612, the second control circuit 634, or a combination thereof. The parameter module 702 can identify the need to establish the dynamic tailored-geofence 308 based on the initiating request 110, pre-defined rules, triggers, and models, or a combination thereof.

The parameter module 702 can determine the targeted exchange 302 of FIG. 3 for identifying the product or the service associated with the initiating request 110 sought by the requesting member 108. The parameter module 702 can determine the targeted exchange 302 based on the information received or accessed from the member characteristic set 206, pre-defined by the requesting member 108, analyzed from the initiating request 110, derived from the contextual information or an event, or a combination thereof.

The parameter module 702 can determine the targeted exchange 302 by matching keywords, accessing values or strings in field entries, using pre-defined scenarios established for the requesting member 108, or a combination thereof In the example of the restaurant wanting to increase happy hour sales, the parameter module 702 can determine the targeted exchange 302 based on the field entry for “goods” in the member characteristic set 206. In a further example, for the taxi service the targeted exchange 302 can be the predefined service of the taxi ride based on the type of business entity.

The parameter module 702 can further determine the corresponding location 316 of FIG. 3 associated with the targeted exchange 302 for identifying the point of interest 318 of FIG. 3 associated with the targeted exchange 302. The parameter module 702 can determine the corresponding location 316 based on the location of the requesting member 108, the information in the member set 202, received information from the requesting member 108, the initiating request 110, or a combination thereof.

For example, the parameter module 702 can determine the corresponding location 316 based on the point of interest 318 or address field entry from the requesting member 108. In a further example, the parameter module 702 can determine the corresponding location 316 using Global Positioning Systems (GPS) coordinates, Indoor Positioning Systems (IPS) coordinates, trilateration of signals, or a combination thereof.

The parameter module 702 can manage the information associated with the map 404 by determining the corresponding location 316, the potential points of interest, possible routes for traversing to a destination, or a combination thereof. The parameter module 702 can further identify areas of the map 404 based on information from the member characteristic set 206, such as the user history or the member context 208, matching a pre-defined profile, keywords, score value, or combination thereof.

For example, the navigation system 100 can identify areas of the map 404 used for establishing the market for the targeted exchange 302. In a further example where the user would like to sell unwanted tickets to a movie, the navigation system 100 can identify areas of the map 404 allowing users to arrive at the movie theater before show time. In the example of the ride service requesting the dynamic tailored-geofence 308 to increase ride sales, the navigation system 100 can identify areas of the map 404 where a large percentage or a large number of users are walking in the direction to accept the ride service.

The parameter module 702 can identify the goal-sharing partners 312 of FIG. 3 associated with the initiating request 110 for representing the user related to the initiating request 110. The parameter module 702 can use predetermined relationships, distance proximity, direct input, or a combination thereof for identifying the goal-sharing partners 312.

After determining the initiating request 110, the targeted exchange 302, the corresponding location 316, the goal-sharing partners 312, or a combination thereof, the control flow can pass from the parameter module 702 to the goal module 704 by storing the processing result from the parameter module 702 for access by the goal module 704. The control flow can further pass by notifying the goal module 704, such as by using a flag, an interrupt, a status signal, or a combination thereof. The control flow can further pass by having the output of the parameter module 702 as an input to the goal module 704.

The goal module 704 is configured to determine the geofence goal 304 of FIG. 3 for establishing the dynamic tailored-geofence 308. The goal module 704 can determine the geofence goal 304 associated with the targeted exchange 302, for representing a condition regarding the product or the service, based on receiving a statement for the geofence goal 304. The goal module 704 can receive the statement for the geofence goal 304 based on the field inquiry from the first user interface 618, the first communication interface 628, the first control interface 622, the first storage interface 624, the location interface 632, the second user interface 638, the second display interface 640, the second control interface 644, the second storage interface 648, or a combination thereof.

The goal module 704 can further determine the geofence goal 304 based on information within the member set 202, the initiating request 110, an event cancelation or other changes to a previous state, or a combination thereof. The goal module 704 can determine the geofence goal 304 based on keyword searches of the information received or stored using the first device 102, the network 104, or the second device 106.

The goal module 704 can utilize predefined rules and a priority for implementing the predefined rules for determining the geofence goal 304. The predefined rules can be based on common scenarios, business type, time of day, the member context 208, or a combination thereof

For example, in the scenario where the navigation system 100 determines the missed arrival or a delayed arrival for the movie tickets purchased for an 8 o'clock show time, the navigation system 100 can suggest initiating processing for the dynamic tailored-geofence 308 with the geofence goal 304 of selling the movie tickets before the 8 o'clock show time. In a further example, the goal module 704 can determine the geofence goal 304 of increasing the number of fares per day when the ride service creates the initiating request 110 for the dynamic tailored-geofence 308.

The goal module 704 can further determine the geofence goal 304 based on determining parameters, values, relationships, conditions, equations, logical statements, machine learning, or a combination thereof based on the initiating request 110 or the need for measuring the geofence goal 304. The goal module 704 can utilize the first control circuit 612, the second control circuit 634, or a combination thereof for determining the geofence goal 304. The goal module 704 can determine the goal parameters 322 of FIG. 3, the goal metric 324 of FIG. 3, the goal time window 320 of FIG. 3, the goal change condition 310 of FIG. 3, the combined goal 314 of FIG. 3, or a combination thereof for establishing the dynamic tailored-geofence 308.

For example, the goal module 704 can determine the goal parameters 322 using information directly received in the initiating request 110, predefined sets of rules based on the category type, keyword searches based on communications from the user, or a combination thereof In a more specific example, the goal module 704 can determine the goal parameters 322 such as “ticket sales”, “available seats” “tickets sold”, and “show time” based on the location category such as the movie theater.

In a further example, the goal module 704 can generate the goal metric 324 associated with the geofence goal 304, for quantifying the geofence goal 304, based on predefined algorithms or rule sets for quantifying meeting the geofence goal 304. For example, the goal metric 324 can be the percentage based on a mathematical relationship between the total number of items and the number of available items, such as:

Goal Metric=Available Number/Total Number*100

The goal module 704 can determine the goal time window 320 for establishing the relevant time for the dynamic tailored-geofence 308. The goal time window 320 can include the future time. For example, the goal module 704 can determine the goal time window 320 for tomorrow between 10 am and 2 pm for the restaurant to draw in customers for during tomorrow's lunch time.

The goal module 704 can establish the goal change condition 310 associated with the goal metric 324 for determining the condition for meeting the geofence goal 304. For example, the goal module 704 can establish the goal change condition 310 using predefined settings provided by the requesting member 108 or an estimation based on the number of available targeted items. The goal module 704 can also receive an update for the goal change condition 310 based on the output from the test module 708.

In a further example, the navigation system 100 can generate the geofence goal 304 to sell a game ticket based on an email notice or scheduled overlap initiating the establishment of the dynamic tailored-geofence 308 for the secondary marketplace 502 of FIG. 5. The goal module 704 can determine the geofence goal 304 to sell the game ticket with the measurable goal being to maximize the ticket price and minimize the user effort.

Further, as game time approaches, for the dynamic tailored-geofence 308 requested by a sports arena, the goal module 704 can determine the geofence goal 304 for maximizing total sales based on time before the game and the number of empty seats. The goal metric 324 can be determined as the product between filled seats and the seat price. By offering seats at reduced prices or selling seat upgrades to fill empty seats, the navigation system 100 can maximize the total sales for the game.

The goal module 704 can also determine the combined goal 314 associated with the goal-sharing partners 312. The goal module 704 can utilize predefined information from the user associated with the initiating request 110 as an input to the navigation system 100, data from the member set 202, a pre-established relationship between establishment categories, such as the distance between establishments or complementary categories, for determining the combined goal 314.

After determining the geofence goal 304 and completing the related processes, the control flow can pass from the goal module 704 to the geofence module 706 by storing the processing result from the goal module 704 for access by the geofence module 706. The control flow can further pass by notifying the geofence module 706, such as by using a flag, an interrupt, a status signal, or a combination thereof. The control flow can further pass by having the output of the goal module 704 as an input to the geofence module 706.

The geofence module 706 is configured to generate the dynamic tailored-geofence 308. The geofence module 706 can generate the dynamic tailored-geofence 308 including a shape or an outline for satisfying the geofence goal 304 associated with the targeted exchange 302. The geofence module 706 can generate the shape or outline for satisfying the geofence goal 304 based on the possible routes to the targeted exchange 302 or the corresponding location 316.

The geofence module 706 can use a shape template or a travel equation to reverse calculate the possible routes from the corresponding location 316 for the targeted exchange 302 to a projected location or a starting point. The geofence module 706 can determine the shape template or the travel equation based on a relationship, an algorithm, a time, a distance, historical data, the goal time window 320, or a combination thereof.

For example, the shape template can include a circular area around the corresponding location 316. The geofence module 706 can calculate a radius for the circular area using various dynamic information and a predetermined equation.

Also for example, the shape template can include municipal boundaries, such as for city blocks or a town, a commonly-known boundary, such as for “downtown”, ethnic towns, or restaurant-dense areas, a natural boundary or divider, such as for bodies of water or geographic formation, man-made geographic dividers, such as roads of certain size or type, or a combination thereof. The geofence module 706 can select the appropriate boundary as one or more edges or sides of the geofence. The geofence module 706 can select based on distance or travel time from the corresponding location 316 for the targeted exchange 302, a probability or a weighting factor representing users' desire or likelihood of traversing across the boundary, historical travel patterns, or a combination thereof

In a further example, the travel equation can include the distance equivalent to a fixed travel time at an estimated travel speed. The travel equation can include the goal time window 320 to establish a maximum allowable time to reach the corresponding location 316. The equation can utilize the estimated travel speed from historical information and the maximum travel time to arrive at an estimated distance for establishing a unique starting point for each of the possible routes. The geofence module 706 can calculate possible routes reaching the corresponding location 316 within the goal time window 320.

The geofence module 706 can utilize the starting point or a projected location of each of the possible routes to draw the non-circular outline 406 of FIG. 4 for the dynamic tailored-geofence 308. For example, the geofence module 706 can draw the non-circular outline 406 by connecting adjacent starting points or adjacent locations along the route. In a further example, the geofence module 706 can draw a line between points using best fit line, linear regression, or trend line techniques. The geofence module 706 can further update the non-circular outline 406 to match a time requirement or a distance requirement based on the output from other modules or submodules as described below.

The geofence module 706 can utilize the location circuit 620, the first control circuit 612, the second control circuit 634, or a combination thereof for calculating and updating the possible routes to the targeted exchange 302 and generating the dynamic tailored-geofence 308. The geofence module 706 can further utilize the first storage circuit 614, the second storage circuit 646, or a combination thereof to store the possible routes.

The geofence module 706 can further include a reachability module 712. The geofence module 706 can include one or more of the submodules to evaluate the effort required to travel to the corresponding location 316 based on the various aspect or contexts as processed by one or more of the submodules.

The reachability module 712 is configured to evaluate the possible routes based on the reachability factor 328 of FIG. 3. The reachability module 712 can calculate the reachability factor 328 based on the corresponding location 316, for representing the effort, the likelihood of traversal, the time, the distance, the travel costs 332 of FIG. 3, or a combination thereof required of the user to reach the corresponding location 316.

The reachability module 712 can calculate and assign the reachability factor 328 for each route according to the effort required to arrive at the corresponding location 316 for the targeted exchange 302. The reachability module 712 can calculate the reachability factor 328 using an algorithm or an equation, based on the time, the distance, the travel costs 332, traffic conditions, natural barriers, such as a river through a city, or a combination thereof.

For example, the reachability module 712 can calculate the reachability factor 328 accounting for the natural or man-made divider or barrier, such as a bridge or the river. The reachability factor 328 assigned for routes avoiding the natural or man-made barrier can be lower than routes including the natural barrier. The reachability module 712 can also exclude routes with city streets and include routes using freeways.

In a further example, the reachability module 712 can calculate the reachability factor 328 based on a summation of weighted values for the time, the travel costs 332, probabilities, or a combination thereof and detour from the current location for the user. The reachability module 712 can assign a low reachability factor to the routes unable or less-likely to arrive at the targeted exchange 302 within the goal time window 320.

The reachability module 712 can modify the route by adjusting its length or starting point. For example, the reachability module 712 can truncated the length of the route for increasing the reachability factor 328. In another example, the reachability module 712 can exclude the natural barrier, such as a bridge or the river, from the route to increase the reachability factor 328. The reachability module 712 can exclude routes with city streets and include routes using freeways.

The reachability module 712 can utilize the resulting starting points for the possible routes meeting the reachability factor 328 predetermined as a threshold value to draw the non-circular outline 406 for the dynamic tailored-geofence 308. The reachability module 712 can generate then non-circular outline 406 for the dynamic tailored-geofence 308 using the separated-area set 402 of FIG. 4 by utilizing unconnected areas for the dynamic tailored-geofence 308. The reachability module 712 can utilize the first control circuit 612, the second control circuit 634, or a combination thereof for evaluating the possible routes for traversing to the targeted exchange 302 or the corresponding location 316.

After determining the non-circular outline 406 for the dynamic tailored-geofence 308, the control flow can pass from the geofence module 706 to the test module 708 by storing the processing result from the geofence module 706 for access by the test module 708. The control flow can further pass by notifying the test module 708, such as by using a flag, an interrupt, a status signal, or a combination thereof.

The test module 708 is configured to evaluate the dynamic tailored-geofence 308 based on the goal metric 324 for meeting the goal change condition 310. The test module 708 can update the dynamic tailored-geofence 308 by accessing information, estimating probabilities, comparing estimated responses with responses needed to achieve the geofence goal 304, monitoring the goal change condition 310, updating the goal change condition 310, or a combination thereof.

The test module 708 can determine the member context 208 for identifying the location of the user at the future time, the member profile 204 for the users within the dynamic tailored-geofence 308, the dynamic benefit level 326 of FIG. 3 based on the member profile 204, or a combination thereof. The test module 708 can determine the member context 208, the member profile 204, the dynamic benefit level 326 based on information in the member profile 204.

The test module 708 can utilize the first communication circuit 616, the first storage circuit 614, the second communication circuit 636, the second storage circuit 646, or a combination thereof to access the member profile 204, the member context 208, the dynamic benefit level 326, or a combination thereof. The test module 708 can utilize the first communication circuit 616, the second communication circuit 636, or a combination thereof for monitoring the goal change condition 310.

The test module 708 can further include a probability module 714, a comparison module 716, or a combination thereof. The test module 708 can include one or more of the submodules to evaluate the possible routes for travel to the corresponding location 316 based on the various aspect or contexts as processed by one or more of the submodules.

The test module 708 can identify members or users, corresponding devices, or a combination thereof currently located in or scheduled to be located within the dynamic tailored-geofence 308. The test module 708 can identify the members or users in a variety of ways.

For example, the test module 708 can determine the current location of the member devices. The test module 708 can determine the current location based on one or more of the location circuits, one or more of the communication circuits, or a combination thereof corresponding to the member devices as known or predetermined by the navigation system 100. The test module 708 can compare the current location with the dynamic tailored-geofence 308 to identify members or users that are currently located within the dynamic tailored-geofence 308.

Also for example, the test module 708 can identify the members or users scheduled to be located within the dynamic tailored-geofence 308 at a future time relevant to the geofence goal 304. The test module 708 can estimate a location for the users or the members at the relevant future time based on corresponding schedules or calendars. The test module 708 can further estimate based on location at the relevant according to historical patterns time.

Continuing with the example, the test module 708 can further estimate based on relevant contextual information, such as home address, work or address, memberships or associations, or a combination thereof. The test module 708 can compare the estimated or scheduled locations to the dynamic tailored-geofence 308 to estimate the members or users likely or scheduled to be within the dynamic tailored-geofence 308.

The probability module 714 is configured to determine the response probability 330 of FIG. 3 for each user within the dynamic tailored-geofence 308. The probability module 714 can calculate the response probability 330 associated with traveling to the corresponding location 316, for representing a likelihood of the user to travel to the corresponding location 316.

For example, the probability module 714 can calculate the response probability 330 for each user within the dynamic tailored-geofence 308 based on the time, the distance, the travel direction, road or path characteristics, or a combination thereof the user needs to travel to the corresponding location 316. In a more specific example, the probability module 714 can calculate a lower probability for users traveling away from the corresponding location 316 based on the assumption that the user will be unwilling to change the travel direction.

In a further example, the probability module 714 can calculate the response probability 330 based on the member profile 204 for the user. The probability module 714 can calculate the response probability 330 based on the target group 210 of FIG. 2, user visitation frequency, historical geofence results, schedules or estimated upcoming events, estimated affinity or importance of the good or service to the potential responder, or a combination thereof. The probability module 714 can calculate the response probability 330 for the user based on an algorithm, relationship, or a summation of weighted values based on meeting pre-determined criteria associated with the likelihood of responding to the targeted exchange 302.

The probability module 714 can assign a threshold value for the goal change condition 310 for qualifying a potential responder. The potential responder can represent the user within the dynamic tailored-geofence 308 having a sufficient probability of responding to the targeted exchange 302 based on the threshold value.

For example, the threshold value for the response probability 330 can be greater than 50% for the user identified as the potential responder. The response probability 330 below 50% can be assigned to the user identified as unlikely to respond. The probability module 714 can estimate the number of qualifying potential responders within the dynamic tailored-geofence 308. The probability module 714 can utilize the first control circuit 612, the second control circuit 634, or a combination thereof to estimate the response probability 330 for the user.

The comparison module 716 is configured to test the dynamic tailored-geofence 308 against the geofence goal 304. The comparison module 716 can determine the number of potential responders based on the response probability 330 of the users within the dynamic tailored-geofence 308.

The comparison module 716 can also determine the number of responses required to effectively meet the geofence goal 304. The comparison module 716 can access the goal change condition 310 for estimating the number of needed responses for meeting the geofence goal 304. The comparison module 716 can use pre-determined rules, equations, and algorithms for estimating the needed number of responses. For example, the comparison module 716 can estimate the number of needed responses for a movie theater based on the number of available seats.

The comparison module 716 can compare the number of the potential responders to responses required for meeting the geofence goal 304. The comparison module 716 can send a communication, a flag, an alert to the geofence module 706 when then number of potential responders is lower than the number of responses required for meeting the geofence goal 304. The geofence module 706 can update the dynamic tailored-geofence 308 to increase the number of potential responders. The geofence module 706 can update by enlarging or redrawing the dynamic tailored-geofence 308 to increase the potential responders.

The comparison module 716 can further monitor the goal change condition 310 associated with the goal metric 324. The comparison module 716 can monitor the goal change condition 310 by periodically accessing the stored instance of the goal change condition 310 from the goal module. Changes to the goal change condition 310 can trigger the comparison module 716 to re-calculate the number of the required responders. The comparison module 716 can send an alert, a trigger, or a signal to the geofence module 706 to adjust the dynamic tailored-geofence 308 when the number of potential responders is greater than the number of required responders, based on the update to the goal change condition 310.

The comparison module 716 can utilize the first control circuit 612, the second control circuit 634, or a combination thereof to determine the number of potential responders, estimate the number of required responders, and compare the number of potential responders with the number of required responders. The comparison module 716 can utilize the first communication circuit 616, the second communication circuit 636, or a combination thereof for accessing the goal change condition 310 and sending the alert, the trigger, or the signal.

After updating the dynamic tailored-geofence 308, the control flow can pass from the test module 708 to the communication module 710 or to the geofence module 706 as discussed above by storing the processing result from the test module 708 for access by the communication module 710 or the geofence module 706. The control flow can further pass by notifying the communication module 710 or the geofence module 706, such as by using a flag, an interrupt, a status signal, or a combination thereof.

The communication module 710 is configured to communicate the goal-targeted message 306 of FIG. 3 to the target group 210. The communication module 710 can communicate the goal-targeted message 306 associated with the targeted exchange 302 by determining the goal-targeted message 306, sending the goal-targeted message 306 to the user within or scheduled to be within the dynamic tailored-geofence 308, the first device 102, the network 104, the second device 106, or a combination thereof.

The communication module 710 can determine the goal-targeted message 306 based on the geofence goal 304, the combined goal 314, or a combination thereof. The communication module 710 can determine the goal-targeted message 306 based on pre-determined messages stored in the member profile 204 provided by the requesting member 108. The communication module 710 can determine the goal-targeted message 306 based on a selection of available messages or can determine the goal-targeted message 306 based on an increasing level benefit for the user, such as adjusting the discount offer.

The communication module 710 can send the goal-targeted message 306 based on an overlap between the member context 208 for identifying the location of the user at the future time and the dynamic tailored-geofence 308. The communication module 710 can monitor the location of the user. The goal-targeted message 306 can be displayed on the user interface based on an overlap between the member context 208, such as the location and the dynamic tailored-geofence 308.

The communication module 710 can modify the goal-targeted message 306 based on the goal metric 324 for meeting the goal change condition 310. The communication module 710 can modify the goal-targeted message 306 to by adding the dynamic benefit level 326 for the targeted exchange 302 to increase the response probability 330 for the user. The goal-targeted message 306 can also be pre-determined by the requesting member 108. For example, the goal-targeted message 306 for a movie theater can have varying levels such as: an announcement of the movie show time, the offer of free popcorn, the offer of free popcorn and soda, the off of a 30% discount on movie tickets.

The communication module 710 can modify the goal-targeted message 306 based on the dynamic benefit level 326. The communication module 710 can modify the goal-targeted message 306 based on the member profile 204 to provide the dynamic benefit level 326 to the user based on historical patterns. The dynamic benefit level 326 can be pre-determined by the requesting member 108. For example, the dynamic benefit level 326 can be varying discounts $1 off, $2 off, $3 off. The communication module 710 can provide a discount of $1 off for a frequent visitor of the establishment, but offer a $5 discount for an infrequent user or the user required to travel farther to the corresponding location 316.

The communication module 710 can utilize the first control circuit 612, the second control circuit 634, or a combination thereof to determine and update the goal-targeted message 306. The communication module 710 can also utilize the first communication circuit 616, the second communication circuit 634, or a combination thereof to communicate the goal-targeted message 306.

In the illustrative use case example, an owner of baseball game tickets can use the dynamic tailored-geofence 308 to establish the secondary marketplace 502 for selling the tickets to a game he cannot attend. The initiating request 110 can be generated by the parameter module 702 based on a scheduling conflict on game day. The goal module 704 can determine the geofence goal 304 of selling the baseball game tickets before game time. The goal module 704 can determine the goal parameters 322, such as 2 tickets. The goal change condition 310 can include selling the game tickets while maximizing the monies received.

Continuing with the example, the geofence module 706 can determine the dynamic tailored-geofence 308 to include users willing to travel up to an hour away to attend the baseball game. The dynamic tailored-geofence 308 can include areas of the surrounding the baseball stadium accessible by train, bus, car, or ferry. As the game day approaches, the communication module 710 can increase the dynamic benefit level 326 for users within the dynamic tailored-geofence 308 by decreasing the sale price of the tickets.

As game time approaches, the test module 708 can monitor the goal change condition 310 and send the alert to the geofence module 706 to update the dynamic tailored-geofence 308 based on the upcoming start of the baseball game. The geofence module 706 can decrease the size of the dynamic tailored-geofence 308 to include only areas directly adjacent to the stadium.

In a further illustrative use case example, the dynamic tailored-geofence 308 can be used to establish the options marketplace 504 of FIG. 5 for selling unused dinner reservations at a crowded restaurant. The restaurant can create the initiating request 110 for the dynamic tailored-geofence 308 for the geofence goal 304 of decreasing the number of empty tables due to reservation no shows. The goal module 704 can determine the goal parameters 322, the goal change condition 310, the goal time window 320 based on pre-determined relationships provided by the requesting member 108.

Continuing with the example, the geofence module 706 can create the dynamic tailored-geofence 308 from the shape template for the area directly surrounding the restaurant. The reachability module 712 can determine the reachability factor 328 for walking routes to the restaurant to arrive within 10 minutes of the dinner reservation.

Further continuing with the example, the test module 708 can identify the potential responders as the users currently on the restaurant waiting list or frequent patrons of the restaurant within the dynamic tailored-geofence 308. The probability module 714 can determine the response probability 330 of each user within the dynamic tailored-geofence 308 and assign higher probabilities to users on the restaurant waiting list or frequent patrons of the restaurant.

Further continuing with the example, the comparison module 716 can calculate and compare the number of potential responders with the number of needed responders corresponding to the number of dinner reservations. The comparison module 716 can determine to increase the dynamic tailored-geofence 308 or adjust the goal-targeted message 306 in order to increase the number of potential responders.

The communication module 710 can send the goal-targeted message 306 for the selling the option to claim the dinner reservation in the event that the current holder of the reservation does not arrive at the restaurant within a specific time limit. The communication module 710 can adjust the dynamic benefit level 326 for the goal-targeted message 306 for each. For example, the goal-targeted message 306 can offer the dinner reservation at different prices based on the position of the user on the waiting list.

It has been discovered that generating the dynamic tailored-geofence 308 for satisfying the geofence goal 304 associated with the targeted exchange 302 provides improved efficiency by allowing the non-circular outline 406 to alter shape and size based on real-time external factors. The navigation system 100 can generate the dynamic tailored-geofence 308 with the separated-area set 402, the non-circular outline 406, or a combination thereof that can be adjusted based on time, such as closing or show time, people's willingness or preference of travel, or season. This distinction can ensure that the dynamic tailored-geofence 308 is not limited to a fixed area.

It has been discovered that updating the dynamic tailored-geofence 308 based on the goal metric 324 for meeting the goal change condition 310 provides increased usability for the requesting member 108. The navigation system 100 can adjust the dynamic tailored-geofence 308 based on likelihood of meeting the geofence goal 304. For example, the parking lot can advertise and even target prices directly to or for nearby potential customers. The navigation system 100 can increase the dynamic tailored-geofence 308 for advertising to a larger area when the parking lot is nearly empty. The navigation system 100 can decrease the dynamic tailored-geofence 308 and advertise to a small area when the parking lot is almost full. The navigation system 100 can further vary the price accordingly. This distinction can ensure the ability for the navigation system 100 to adjust the dynamic tailored-geofence 308 in response to changes in circumstance to meet the geofence goal 304.

It has been discovered that generating the dynamic tailored-geofence 308 based on driving algorithms provides more relevant geofence boundary determination. The navigation system 100 can determine the non-circular outline 406 of the dynamic tailored-geofence 308 for the potential responders to arrive at the corresponding location 316 within the goal time window 320. This distinction ensures potential responders to the goal-targeted message 306 are both in proximity of the corresponding location 316 and can arrive at the corresponding location 316 for the targeted exchange 302 before the end of the goal time window 320.

It has been discovered that calculating the response probability 330 for representing the likelihood of the user to travel to the corresponding location 316 for generating the dynamic tailored-geofence 308 provides increase effectiveness for the requesting member 108. The navigation system 100 can customize the dynamic tailored-geofence 308 based on the target group 210 to locate areas within the dynamic tailored-geofence 308 where clusters of potential responders exist. The navigation system 100 can adjust the non-circular outline 406 of the dynamic tailored-geofence 308 to include areas where the clusters exist. This distinction ensures the dynamic tailored-geofence 308 can communicate the goal-targeted message 306 to the smallest area possible and still reach the geofence goal 304.

It has further been discovered that the goal-targeted message 306 based on the dynamic tailored-geofence 308 accounting for the response probability 330 increases the relevancy of the goal-targeted message 306. The increased relevancy can be based on considering region or location of the potential responders, thereby distinguishing the goal-targeted message 306 from spam advertisements.

It has been discovered that generating the combined goal 314 associated with the goal-sharing partners 312 and determining the goal-targeted message 306 based on the combined goal 314 provides improved resource sharing. The navigation system 100 can identify the goal-sharing partners 312 based on user input. The ability to partner between two or more partners can help the requesting member 108 enter sales markets, which may have been previous not accessible. This distinction ensures the ability for users associated with the initiating request 110 to reach new customers.

It has been discovered that the dynamic tailored-geofence 308 can establish or improve effectiveness of the options marketplace 504 or the secondary marketplace 502, which further provides improved marketing opportunities for products for unused products. The navigation system 100 can establish the market for selling unused items for users of the dynamic tailored-geofence 308. This distinction ensures added capability to sell items not longer used and can increase participation for location monitoring by allowing users to take advantage of the dynamic tailored-geofence 308.

It has further been discovered that the navigation system 100 generating the dynamic tailored-geofence 308 can be implemented in a variety of situations to provide improved business needs. For example, the reachability algorithm and cost model for travel used in generating the dynamic tailored-geofence 308, as discussed above, can be leveraged to implement real-time coupons, dynamic promotional pricing, or a combination thereof Also for example, the reachability algorithm and cost model for travel can further be leveraged to provide increased efficiency in scheduling transport, especially for perishable goods or in large scale shipping hubs.

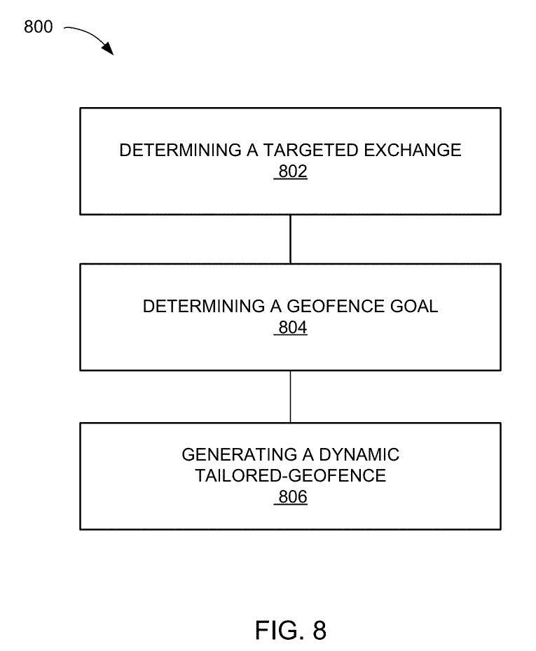

Referring now to FIG. 8, therein is shown a flow chart of a method 800 of operation of a navigation system 100 of FIG. 1 in an embodiment of the present invention. The method 800 includes: determining a targeted exchange for identifying a product or a service associated with the initiating request 110 in a box 802; determining a geofence goal associated with the targeted exchange, for representing a condition regarding the produce or the service in a box 804; and generating a dynamic tailored-geofence including a shape for satisfying the geofence goal associated with the targeted exchange in a box 806

The modules described in this application can be hardware implementation or hardware accelerators, including passive circuitry, active circuitry, or both, in the first storage circuit 614 of FIG. 6, the second storage circuit 646 of FIG. 6, the first control circuit 612 of FIG. 6, the second control circuit 634, of FIG. 6, or a combination thereof. The modules can also be hardware implementation or hardware accelerators, including passive circuitry, active circuitry, or both, within the first device 102 of FIG. 1, the second device 106 of FIG. 1, or a combination thereof but outside of the first storage circuit 614, the second storage circuit 646, the first control circuit 612, the second control circuit 634, or a combination thereof.

The navigation system 100 has been described with module functions or order as an example. The navigation system 100 can partition the modules differently or order the modules differently. For example, the navigation system 100 can utilize the reachability module 712 of FIG. 7 and the probability module 714 of FIG. 7 as main modules instead of sub-modules. The geofence module 706 of FIG. 7 can generate the dynamic tailored-geofence 308 of FIG. 3. The test module 708 of FIG. 7 can evaluate the dynamic tailored-geofence 308 based on the reachability factor 328 of FIG. 3 and the response probability 330 of FIG. 3 calculated by the reachability module 712 and probability module 714, respectively.

In a further example, the navigation system 100 can implement the geofence module 706, the reachability module 712, the probability module 714, or a combination thereof in parallel, in series, or a combination of configuration thereof relative to each other. Continuing with the example, the reachability module 712 can be further divided into submodules based on distance, time, and the travel costs 332 of FIG. 3.

For illustrative purposes, the various modules have been described as being specific to the first device 102 or the second device 106. However, it is understood that the modules can be distributed differently. For example, the various modules can be implemented in a different device, or the functionalities of the modules can be distributed across multiple devices. Also as an example, the various modules can be stored in a non-transitory memory medium

As a more specific example, one or more modules described above can be stored in the non-transitory memory medium for distribution to a different system, a different device, a different user, or a combination thereof, for manufacturing, or a combination thereof Also as a more specific example, the modules described above can be implemented or stored using a single hardware circuit, such as a chip or a processor, or across multiple hardware circuit.

The modules described in this application can be stored in the non-transitory computer readable medium. The first storage circuit 614, the second storage circuit 646, or a combination thereof can represent the non-transitory computer readable medium. The first storage circuit 614, the second storage circuit 646, or a combination thereof, or a portion therein can be removable from the first device 102, the second device 106, or a combination thereof. Examples of the non-transitory computer readable medium can be a non-volatile memory card or stick, an external hard disk drive, a tape cassette, or an optical disk.

The physical transformation of the dynamic tailored-geofence 308 associated with the targeted exchange 302 of FIG. 3 results in the movement in the physical world, such as for the non-circular outline 406 on the map 404 displayed or recreated for the user on one or more of the devices or physical displacement of the user carrying the first device 102 for initiating the request for the dynamic tailored-geofence 308. Movement in the physical world results in updates to the goal-targeted message 306 of FIG. 3, number or locations of responding users, the corresponding location 316 of FIG. 3, the member context 208 of FIG. 2, a combination thereof which can be fed back into the navigation system 100 and further influence the dynamic tailored-geofence 308 or the dynamic benefit level 326 of FIG. 3 offered in the goal-targeted message 306, or a combination thereof.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A navigation system comprising:
a control circuit configured to:
determine a targeted exchange for identifying a product or a service associated with the initiating request,
determine a geofence goal associated with the targeted exchange for representing a condition regarding the product or the service,
generate a dynamic tailored-geofence including a shape for satisfying the geofence goal associated with the targeted exchange; and
a storage circuit, coupled to the control circuit, configured to store the dynamic tailored-geofence.

2. The system as claimed in claim 1 wherein the control circuit is configured to:
determine a corresponding location associated with the targeted exchange, for identifying a point of interest associated with the targeted exchange within the dynamic tailored-geofence;
calculate a response probability associated with traveling to the corresponding location, for representing a likelihood of the user to travel to the corresponding location; and
generate the dynamic tailored-geofence associated with the response probability.

3. The system as claimed in claim 1 wherein the control circuit is configured to:
determine a corresponding location associated with the targeted exchange, for identifying a point of interest associated with the targeted exchange within the dynamic tailored-geofence;
calculate a reachability factor based on the corresponding location, for representing an effort required of the user to reach the corresponding location based on time, distance, costs, or a combination thereof; and
generate the dynamic tailored-geofence based on the reachability factor.

4. The system as claimed in claim 1 wherein the control circuit is configured to:
identify goal-sharing partners associated with the initiating request, for representing the user related to the initiating request;
determine a combined goal associated with the goal-sharing partners; and
determine a goal-targeted message based on the combined goal.

5. The system as claimed in claim 1 wherein the control circuit is configured to:
determine a goal-targeted message associated with the targeted exchange;
determine a member profile for users within the dynamic tailored-geofence;
determine a dynamic benefit level based on the member profile; and
modify the goal-targeted message based on the dynamic benefit level.

6. The system as claimed in claim 1 wherein the control circuit is configured to:
generate a goal metric associated with the geofence goal; and
establish a goal change condition associated with the goal metric; for determining a condition for meeting the geofence goal;
monitor the goal change condition associated with the goal metric; and
update the dynamic tailored-geofence based on the goal metric for meeting the goal change condition.

7. The system as claimed in claim 1 wherein the control circuit is configured to:
generate a goal metric associated with the geofence goal, for quantifying the geofence goal;
establish a goal change condition associated with the goal metric for determining a condition for meeting the geofence goal;
determine a goal-targeted message associated with the targeted exchange; and
modify the goal-targeted message based on the goal metric for meeting the goal change condition.

8. The system as claimed in claim 1 wherein the control circuit is configured to:
determine a goal-targeted message;
determine a member context for identifying a location of a user at a future time; and
send the goal-targeted message based on an overlap between the member context and the dynamic tailored-geofence.

9. The system as claimed in claim 1 wherein the control circuit is configured to:
determine a goal-targeted message; and
establish a secondary marketplace 502 to communicate the goal-targeted message, for representing implementations of the dynamic tailored-geofence for direct transactions between consumers.

10. The system as claimed in claim 1 wherein the control circuit is configured to:
determine a goal-targeted message; and
establish an options marketplace to communicate the goal-targeted message, for representing implementations of the dynamic tailored-geofence for un-consumed resources.

11. A method of operation for a navigation system comprising:
determining a targeted exchange for identifying a product or a service associated with the initiating request;
determining a geofence goal associated with the targeted exchange for representing a condition regarding the product or the service; and
generating, with a control circuit, a dynamic tailored-geofence including a shape for satisfying the geofence goal associated with the targeted exchange.

12. The method as claimed in claim 11 wherein:
determining the targeted exchange includes determining a corresponding location associated with the targeted exchange, for identifying a point of interest associated with the targeted exchange within the dynamic tailored-geofence; and
generating the dynamic tailored-geofence includes:
calculating a response probability associated with traveling to the corresponding location, for representing a likelihood of the user to travel to the corresponding location; and
generating the dynamic tailored-geofence associated with the response probability.

13. The method as claimed in claim 11 wherein:
determining the targeted exchange includes determining a corresponding location associated with the targeted exchange, for identifying a point of interest associated with the targeted exchange within the dynamic tailored-geofence; and
generating the dynamic tailored-geofence includes:
calculating a reachability factor based on the corresponding location, for representing an effort required of the user to reach the corresponding location based on time, distance, costs, or a combination thereof; and
generating the dynamic tailored-geofence based on the reachability factor.

14. The method as claimed in claim 11 wherein:
determining the targeted exchange includes identifying goal-sharing partners associated with the initiating request, for representing the user related to the initiating request;
determining a geofence goal includes determining a combined goal associated with the goal-sharing partners; and
further comprising:
determining a goal-targeted message based on the combined goal.

15. The method as claimed in claim 11 further comprising:
determining a goal-targeted message associated with the targeted exchange;
determining a member profile for users within the dynamic tailored-geofence;
determining a dynamic benefit level based on the member profile; and
modifying the goal-targeted message based on the dynamic benefit level.

16. A non-transitory computer readable medium including instructions for execution by a control circuit, the instructions comprising:
determining a targeted exchange for identifying a product or a service associated with the initiating request;
determining a geofence goal associated with the targeted exchange for representing a condition regarding the product or the service; and
generating a dynamic tailored-geofence including a shape for satisfying the geofence goal associated with the targeted exchange.

17. The non-transitory computer readable medium with the instructions as claimed in claim 16 wherein:
determining the targeted exchange includes determining a corresponding location associated with the targeted exchange, for identifying a point of interest associated with the targeted exchange within the dynamic tailored-geofence; and
generating the dynamic tailored-geofence includes:
calculating a response probability associated with traveling to the corresponding location, for representing a likelihood of the user to travel to the corresponding location; and
generating the dynamic tailored-geofence associated with the response probability.

18. The non-transitory computer readable medium with the instructions as claimed in claim 16 wherein:
determining the targeted exchange includes determining a corresponding location associated with the targeted exchange, for identifying a point of interest associated with the targeted exchange within the dynamic tailored-geofence; and
generating the dynamic tailored-geofence includes:
calculating a reachability factor based on the corresponding location, for representing an effort required of the user to reach the corresponding location based on time, distance, costs, or a combination thereof; and
generating the dynamic tailored-geofence based on the reachability factor.

19. The non-transitory computer readable medium with the instructions as claimed in claim 16 wherein:
determining the targeted exchange includes identifying goal-sharing partners associated with the initiating request, for representing the user related to the initiating request;
determining a geofence goal includes determining a combined goal associated with the goal-sharing partners; and
further comprising:
determining a goal-targeted message based on the combined goal.

20. The non-transitory computer readable medium with the instructions as claimed in claim 16 further comprising:
determining a goal-targeted message associated with the targeted exchange;
determining a member profile for users within the dynamic tailored-geofence;
determining a dynamic benefit level based on the member profile; and
modifying the goal-targeted message based on the dynamic benefit level.
